(19) United States
(12) Patent Application Publication
(10) Pub. No.: US 2014/0319969 A1
(43) Pub. Date: Oct. 30, 2014

(54) FLEXIBLE STRUCTURE FOR GENERATING ELECTRICAL ENERGY FROM WAVE MOTIONS

(71) Applicants: Istvan Denes, Waiblinge/Hohenacker (DE); Gabriele Michalke, Stuttgart (DE); Benjamin Hagemann, Norderstedt (DE); Matthias Grauer, Frankfurt Am Main (DE)

(72) Inventors: Istvan Denes, Waiblinge/Hohenacker (DE); Gabriele Michalke, Stuttgart (DE); Benjamin Hagemann, Norderstedt (DE); Matthias Grauer, Frankfurt Am Main (DE)

(21) Appl. No.: 14/235,882

(22) PCT Filed: Jul. 16, 2012
(86) PCT No.: PCT/EP2012/063888

§ 371 Date: Jun. 3, 2014

(30) Foreign Application Priority Data
Jul. 29, 2011 (DE) 10 2011 080 120.0

(51) Int. Cl. F03B 13/20; H02N 2/18

(52) U.S. Cl. CPC F03B 13/20; H02N 2/18
USPC 310/339

(57) ABSTRACT

A device for generating electrical energy from the motion of waves includes: at least one flexible, floatable tube which is closed at its two ends and includes a wall having at least one horizontal stack, which extends in the longitudinal direction of the tube and has at least one layer having one tier made of an electroactive polymer and at least one tier serving as a flexible electrode. The tube is exposed to the wave motions of water such that sections of the stacks are strained or compressed, and the layers of the electroactive polymers in the compressed sections are charged with the aid of control electronics, and thereafter excess electrical energy resulting from relaxation of these sections and the associated separation of the charges in the electroactive polymer is extracted by a capacitive discharge.

### BACKGROUND OF THE INVENTION

1. Field of the Invention

The present invention relates to a flexible structure for generating electrical energy from wave motions.

2. Description of the Related Art

The kinetic energy of waves may be used to generate electrical energy. One option, for example, is to use floating bodies which are movably joined to each other and whose movement relative to each other drives a generator. Such devices are known from the published European patent document EP 1 115 976 B1, for example, where a device for generating energy from waves is claimed which includes a plurality of floating body members, which are joined to each other to form an articulated structure, each pair of adjoining body members being joined to the other via a coupling part in such a way that a relative rotational movement of the body members is possible, each coupling part including an element which is adapted to generate energy from the relative rotational movement of the body members, and the device further including means to apply a roll bias angle away from the horizontal and/or vertical direction to the axis of the relative rotational movement on each coupling part. This device is characterized by including variable constraining means which are provided on every coupling part and which are adapted to apply periodically varying constraints to the relative rotation of every pair of adjoining body members in response to the prevailing state of the sea.

Kinetic energy may also be converted into electrical energy with the aid of electroactive polymers (EAP). This requires recurring cycles of deformation and relaxation of the electroactive polymer. Electroactive polymers are characterized in that they change their shape when an electrical voltage is applied. As a result, electroactive polymers are used as actuators. As an alternative, EAPs allow an operation as a generator, in which mechanical strain energy is directly converted into electrical energy. The conversion takes place on a capacitive basis by the shifting of charges. During the generation of energy with the aid of electroactive polymers, the generator, including two resilient electrodes between which the electroactive polymer is introduced, is strained as a result of the action of an external force. In the state of maximal strain of the electroactive polymer generator, the assembly is acted upon by electrical charges below the breakdown field strength. When the action of the external force is reduced, the generator relaxes due to the elastic effect of the polymer. During this phase, the energy stored in the generator increases. This process constitutes the actual conversion of the mechanical movement into the electrical energy. As soon as the generator is completely relaxed, the assembly is discharged, whereby the generator returns to its original length. The energy generation cycle may start again.

### BRIEF SUMMARY OF THE INVENTION

The present invention provides a device for generating electrical energy from the motion of waves, or for converting kinetic energy into electrical energy, requiring no hydraulic transmission of the wave motion to a hydraulic motor, but instead using the electroactive polymers for power generation. The present invention further provides a method for generating electrical energy from the motion of waves, in which the kinetic energy is converted into electrical energy with the aid of electroactive polymers.

The device according to the present invention includes at least one flexible, floatable tube which is closed at both ends so that a hollow structure is formed. The tube is characterized by including a wall having at least one horizontal stack which extends in the longitudinal direction of the flexible, floatable tube and which includes at least one layer, having one tier made of an electroactive polymer and at least one tier serving as a flexible electrode. The tier made of an electroactive polymer and the electrode tier(s) of each layer are in direct contact with each other. The electrode tiers may be metallic or formed of conductive polymers.

In one specific embodiment, the wall of the flexible, floatable tube has multiple horizontal stacks extending in parallel to each other. In specific embodiments having multiple stacks extending in parallel to each other, these strands are joined to each other in a way that is impermeable to water and/or gas. The joining may be carried out, for example, by bonding or welding adjoining strands to each other. However, the strands may also be embedded into another material, preferably a polymer.

According to one specific embodiment, the at least one stack has multiple immediately consecutive layers, of which each layer is composed of one tier of an electroactive polymer and one tier serving as a flexible electrode. In this specific embodiment, the at least one stack has multiple two-tier layers so that the electrode tier of the one layer is also in contact with the tier made of an electroactive polymer of the next layer of the stack, and thus is the second electrode for the electroactive polymer of the subsequent layer.

According to one alternative specific embodiment, the at least one stack has multiple layers, of which each layer is composed of one tier of an electroactive polymer which is situated between two tiers serving as flexible electrodes, consecutive layers being separated from each other by at least one insulating tier. In this specific embodiment, the at least one stack has multiple three-tier layers, in which one tier of an electroactive polymer is flanked on both surfaces in each case by an electrode tier. The electrode tiers of adjoining layers are separated from each other in an electrically non-conducting manner by at least one interposed insulating tier, for example made of a non-conductive polymer. This specific embodiment offers the particular advantage that the flexibility of the device according to the present invention may be adjusted via the material selection for the insulating tiers and their thicknesses.

The stacks may be stacks made of consecutive, separate layers of a non-conductive polymer and of an electroactive polymer.

This means that the at least one stack is not designed in one piece. In one other specific embodiment, the layers may be designed as a one-piece component, for example by appropriately folding a film strip made of an electroactive polymer and/or an electrode strip, for example by fanfolding of this strip.

In one alternative specific embodiment, the flexible, floatable tube is formed of at least one helically wound strip which includes one tier of an electroactive polymer and at least one electrode tier, the tier of the electroactive polymer preferably being designed in the form of ring segments which are separated from each other. As an alternative, the helically wound strip may include a tier of an electroactive polymer, which is situated between two electrode tiers, and an insulating tier on at least one side of the strip. In this specific embodiment, the consecutive windings of the helix are fixedly joined to each other in a way that is impermeable to water and/or gas, so that they form the wall of the resulting flexible tube, the segments made of an electroactive polymer which are situated behind each other forming a stack.

The number of ring segments per winding of the helix (corresponding to 360°) may vary. In one specific embodiment, each winding may have two segments. With this specific embodiment, it is possible to use the movement of the helix in one plane for power generation. Each winding of the helix preferably has more than two ring segments, particularly preferably 4 ring segments. Each winding of the helix may also have 3, 5, 6, 7, 8, 9, 10, 11, 12 or more ring segments made of an electroactive polymer. More than 2 ring segments made of an electroactive polymer per winding of the helix allow the wave motion to be used, regardless of its direction.

All windings of the helix preferably have the same number of ring segments made of an electroactive polymer. However, the number of ring segments per winding in the cylindrical structure may also vary in relation to each other.

Regardless of the design of the wall of the tubes, the tubes are not open, but are closed at their two mutually opposing ends. In one specific embodiment, the tubes are closed by plates which are situated at the ends of the tube over the particular aperture. By closing the flexible tube, a cavity is formed in the interior which lends the tube its floatability.

In one specific embodiment, the flexible, floatable tube has a flexible spine in its cavity. The spine essentially extends over the entire length of the cavity and is made of a flexible material, which is adaptable to the wave motion. The spine may be a rod, a rope or a thin tube. The spine in the interior of the flexible, floatable tube prevents buckling or distortion of the flexible, floatable tube under large loads.

In one preferred specific embodiment, the flexible, floatable tube has spacers which are situated at certain intervals from each other along the longitudinal direction of the flexible, floatable tube. The spacers hold the spine in the interior of the flexible, floatable tube at essentially the same distance from the wall of the tube.

In one alternative or additional specific embodiment, the flexible, floatable tube has rings which surround the flexible, floatable tube or are integrated into the wall of the flexible, floatable tube between two layers of the stacks. The rings are situated at certain intervals from each other along the longitudinal direction of the flexible, floatable tube. The rings may be made of a metal, preferably steel, particularly preferably stainless steel, or of a polymer. By positioning the rings at certain intervals along the longitudinal axis of the flexible, floatable tube, buckling or distortion of the flexible, floatable tube is preventable.

In one further or additional specific embodiment, the cavity of the flexible, floatable tube is filled with a gas, a gas mixture or a liquid. For example, the liquid may be seawater. The filling of the cavity is preferably pressurized so that the forces acting from the outside on the structure, which may result in buckling or distortion of the flexible, floatable tube, are at least partially compensated for. The hollow, cylindrical structure may have at least one valve, with the aid of which the pressure of the filling is adjustable or controllable.

The device further includes control electronics, i.e., at least one electronic circuit, with the aid of which it is possible to switch back and forth between different sections of a stack to provide the initial charge, which is necessary for the power generation from wave motion with the aid of electroactive polymers, for one layer made of an electroactive polymer, or for the layers made of an electroactive polymer, in one section of the flexible, floatable tube.

In one preferred specific embodiment, different stacks made of consecutive layers and/or different sections of the same stack or of different stacks are connected to each other by the control electronics in such a way that a portion of the electrical energy generated during the discharge phase of the electroactive polymer of a stack section is usable for the initial charge of the layers made of an electroactive polymer of another section which are in the charging phase.

With its flexible, floatable tube, the device according to the present invention allows better adaptation of its movement to the wave motion than rigid floating bodies which are hinged together. In this way, power generation with the aid of electroactive polymers becomes possible, even with a relatively small swell. The device according to the present invention may be moored to the ocean bed and connected to land via a current-conducting cable.

The present invention covers a method for generating electrical energy from the motion of waves, i.e., from the kinetic energy of the waves, in particular a method in which the device according to the present invention is used.

In the method according to the present invention, the flexible, floatable tube floats on the water, preferably on the ocean, and is exposed to the wave motions. The flexible, floatable tube is bent by its own weight in the areas of the wave troughs and wave crests.

As a result, sections of the stacks are strained or compressed. In the area of the wave trough, the stack sections located in the water are strained and the stack sections opposite thereof and facing away from the water surface are compressed. In contrast, in the area of the wave crest, the stack sections located in the water are compressed and the stack sections opposite thereof and facing away from the water surface are strained. As a result of the continual wave motions, all stacks, stack sections and layers made of an electroactive polymer are subjected to a constantly recurring cycle of compression and strain. These cycles are used to generate electrical energy.

The generation of the electrical energy, or the power generation, using the device according to the present invention includes the following phases:
1. some sections of the stacks having the layers made of an electroactive polymer situated there are compressed;
2. the layers of electroactive polymers in these compressed sections are charged with the aid of control electronics;
3. the compressed sections of the stacks relax, and the charges in the layers made of an electroactive polymer are separated by the increasing distance of the electrodes connected to the layers; and
4. the excess electrical energy of the electroactive polymers is extracted with the aid of a capacitive discharge phase.

The method for generating electrical energy from wave motions is characterized in that the at least one flexible, floatable tube of a device, the device including at least one flexible, floatable tube which is closed at its two ends and includes a wall having at least one horizontal stack, which extends in the longitudinal direction of the tube and has at least one layer, including one tier made of an electroactive polymer and at least one tier serving as a flexible electrode, is exposed to the wave motions of water, sections of the stacks being strained or compressed, and the layers of the electroactive polymers in the compressed sections being charged with the aid of control electronics, and thereafter the excess electrical energy resulting from the relaxation of these sections and the associated separation of the charges in the electroactive polymer of this area being extracted by a capacitive discharge phase.

The present invention is described in greater detail hereafter with reference to the drawings and concrete exemplary embodiments. It must be taken into consideration that neither the drawings nor the concrete specific embodiments used for the description shall be construed to limit the present invention.

### BRIEF DESCRIPTION OF THE DRAWINGS

FIG. 1 shows a schematic illustration of a longitudinal section of a flexible, floatable tube 1 of a device according to the present invention.

FIG. 2 shows a schematic cross section taken along line A-A through the flexible, floatable tube 1 shown in FIG. 1.

FIG. 3 shows another embodiment of the flexible, floatable tube of a device according to the present invention.

FIG. 4 shows a schematic cross section taken along line B-B through the flexible, floatable tube shown in FIG. 3.

FIG. 5 shows another embodiment of the flexible, floatable tube of a device according to the present invention.

FIG. 6 shows a schematic cross section taken along line C-C through the flexible, floatable tube shown in FIG. 5.

FIG. 7 illustrates an example composition of a stack 30 made of consecutive layers.

FIG. 8 shows an alternative embodiment in which the flexible, floatable tube is formed by a helically wound strip.

FIG. 9 shows a schematic cross section taken along line D-D through the embodiment shown in FIG. 8.

### DETAILED DESCRIPTION OF THE INVENTION

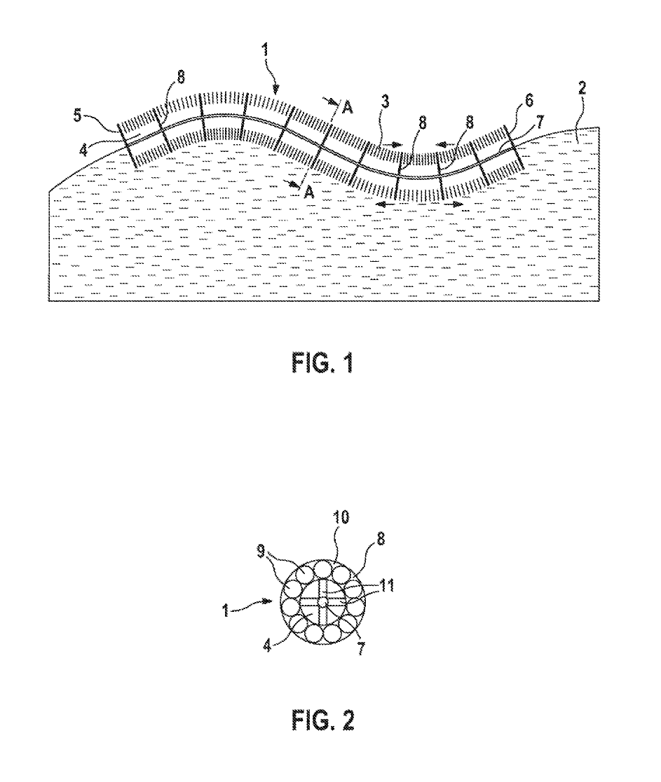

FIG. 1 shows a schematic illustration of a longitudinal section of a flexible, floatable tube 1 of a device according to the present invention. Flexible, floatable tube 1 floats on water 2. Flexible, floatable tube 1 has an essentially circular cylinder wall 3 which is essentially composed of strands 9 extending in parallel to each other, each of the strands being composed of a stack of consecutive layers, including one tier of an electroactive polymer, and delimiting a cavity 4. Flexible, floatable tube 1 is closed at its two ends with respect to its longitudinal extension, for example by a first plate 5 at one of its ends and by a second plate 6 at its other, second end located opposite the first end. Two plates 5, 6 delimit cavity 4 at the ends of flexible, floatable tube 1. Flexible, floatable tube 1 has a spine 7 which extends essentially over the entire length of flexible, floatable tube 1 and runs in the center of flexible, floatable tube 1, relative to the circular cross section. Flexible, floatable tube 1 further has spacers 8 which are situated at regular intervals along the longitudinal axis of flexible, floatable tube 1 and hold the spine at an essentially constant distance from cylinder wall 3.

Tube 1 is floatable and so flexible that it is adaptable to the motion of water 2 on its surface, i.e., the wave topography. Sections of flexible, floatable tube 1 are bent as a result, the wall areas of the bent sections which have a smaller radius than the spine in the same section being compressed, and the areas of the same bent section which are located opposite these areas and which have a larger radius than the spine in the same section being strained, relative to the extended rectilinear rest position of flexible, floatable tube 1. A compressed area is indicated in FIG. 1 by the black arrows pointing toward each other, and a strained area is indicated by the two black arrows pointing away from each other.

FIG. 2 shows a schematic cross section through a flexible, floatable tube 1 according to FIG. 1 along line A-A and illustrates that the wall of the tube is essentially composed of strands 9 which extend in parallel to each other and which are connected to each other in a way that is impermeable to water and/or gas. Spacer 8 may be made of a ring 10 provided with boreholes, the strands extending through the boreholes. The spacer has at least one strut which extends from the inner side of the tube wall to spine 7. The spacer preferably has multiple struts 11, particularly preferably 2, 3, 4, 5, 6 or 8 cross struts, which extend from the inner edge of ring 10 to spine 7.

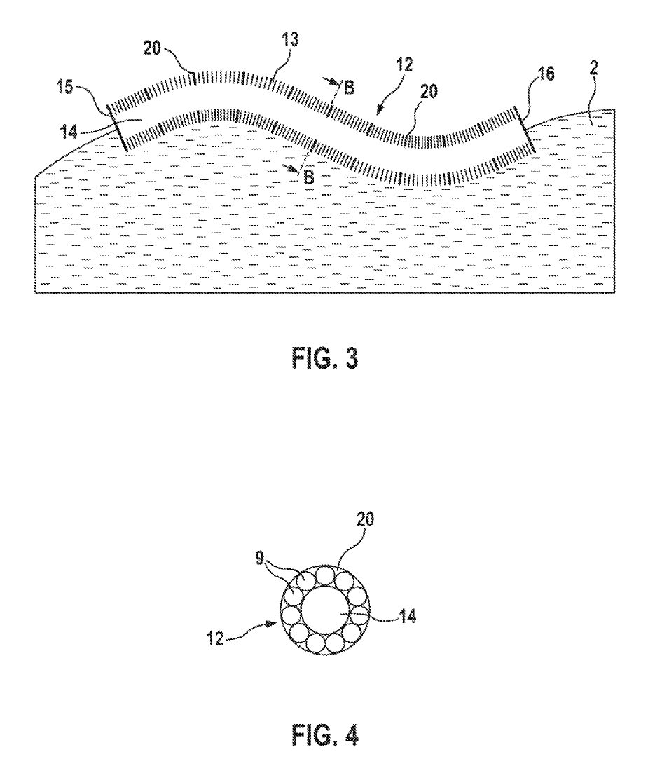

FIGS. 3 and 4 show another specific embodiment of the flexible, floatable tube of a device according to the present invention, FIG. 4 showing a cross section through flexible, floatable tube 12 illustrated in the longitudinal section in FIG. 3 along line B-B. Flexible, floatable tube 1 floating on water 2 has an essentially circular wall 13, which is essentially composed of strands 9 extending in parallel to each other and delimiting a cavity 14. Tube 12 is closed at its two ends with respect to its longitudinal extension, for example by a first plate 15 on one end and by a second plate 16 at the opposite end. Two plates 15, 16 delimit cavity 14 at the ends of structure 12.

Tube 12 further has rings 20 which are provided with boreholes, strands 9 running through their walls, and which are situated at regular intervals from each other along tube 12.

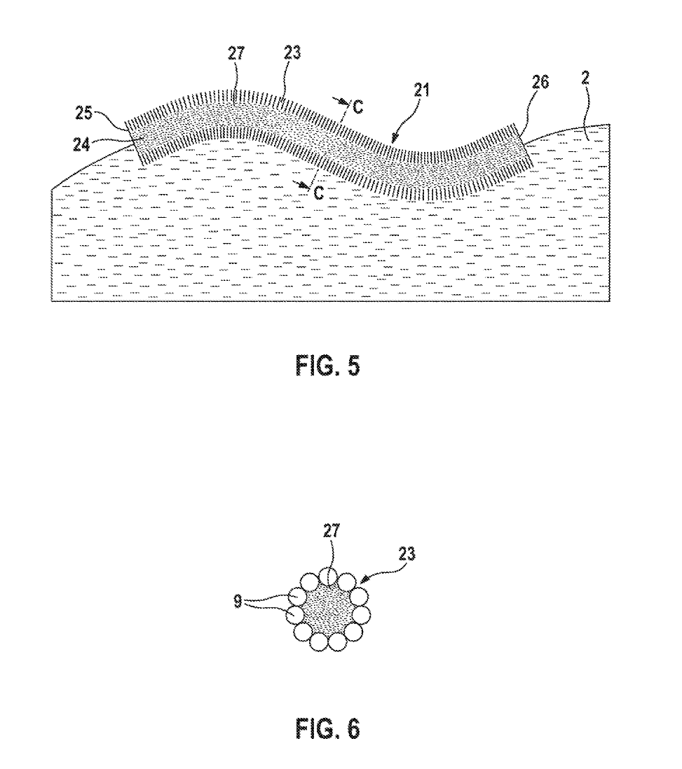

FIGS. 5 and 6 show another specific embodiment of the flexible, floatable tube of a device according to the present invention, FIG. 6 showing a cross section through flexible, floatable tube 21 illustrated in the longitudinal section in FIG. 5 along line C-C. In this specific embodiment, cavity 24 is delimited by strands 9, which essentially run in parallel to each other and which are formed of stacks of consecutive layers, including one tier of an electroactive polymer, and which are embedded into another material 23, and by plates 25 and 26 situated on the opposing ends of tube 21. Cavity 24 is filled with a fluid 27, i.e., a gas, a gas mixture or a liquid, preferably water, particularly preferably seawater.

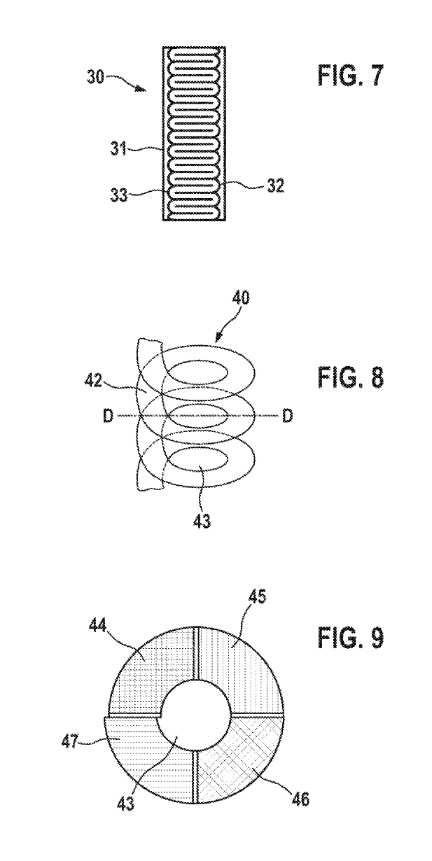

FIG. 7 illustrates the possible composition of a stack 30 made of consecutive layers. In this specific embodiment, stack 30 is situated in a hose-like envelope 31. Stack 30 is made of a periodic sequence of tiers which are located on top of each other and are made of an electroactive polymer 32 and an electrode tier 33, the tiers made of an electroactive polymer on the one hand and the electrode tiers on the other hand being present as tiers which are not entirely separated from each other, but which are joined to each other in an outer area of stack 30 and are thus designed in one piece, so that the tiers are “interlocked” with each other in a zipper-like manner.

FIG. 8 shows one alternative specific embodiment, in which the flexible, floatable tube is formed by a helically wound strip 42. Strip 42 includes one layer of an electroactive polymer. The windings of strip 42 are joined to each other in a gas- and/or watertight manner, so that a tube is created in which the helically wound strip forms the wall, which surrounds a cavity 43 when the individual windings of strip 42 are situated directly on top of each other.

FIG. 9 shows a cross section through one specific embodiment according to FIG. 8 along line D-D and shows an assembly of 4 segments (44, 45, 46, 47) made of an electroactive polymer which are present in each complete winding, so that in the case of a tube that is formed of this strip four stacks extending in parallel to each other are formed, the stacks being made of consecutively positioned tiers which are made of an electroactive polymer and one electrode in each case.

1-10. (canceled)

11. A device for generating electrical energy from the motion of waves, comprising:
at least one flexible, floatable tube which is closed at two ends;
wherein the flexible, floatable tube includes a wall which has at least one horizontal stack extending in the longitudinal direction of the flexible, floatable tube, and wherein the at least one stack has at least one layer which includes one tier made of an electroactive polymer and at least one tier serving as a flexible electrode.

12. The device as recited in claim 11, wherein the at least one stack has multiple immediately consecutive layers which each include one tier of the electroactive polymer and one tier serving as the flexible electrode.

13. The device as recited in claim 11, wherein the at least one stack has multiple layers which each include one tier of the electroactive polymer situated between two tiers serving as the flexible electrodes, and wherein consecutive layers are separated from each other by at least one insulating tier.

14. The device as recited in claim 11, wherein the flexible, floatable tube is formed of at least one helically wound strip which includes one tier of the electroactive polymer, and wherein the one tier of the electroactive polymer includes segments which are separated from each other.

15. The device as recited in claim 14, wherein each winding of the helically wound strip has at least two ring segments made of the electroactive polymer.

16. The device as recited in claim 11, wherein the flexible, floatable tube has a flexible spine in the interior cavity of the tube, the flexible spine extending over essentially the entire length of the cavity of the tube.

17. The device as recited in claim 16, wherein the flexible, floatable tube has spacers which (i) are situated at predefined intervals from each other along the longitudinal direction of the flexible, floatable tube and (ii) hold the spine in the interior cavity of the flexible, floatable tube at an essentially uniform distance from the wall of the tube.

18. The device as recited in claim 12, wherein the flexible, floatable tube has rings which (i) are situated at predetermined intervals from each other along the longitudinal direction of the flexible, floatable tube and (ii) one of surround the flexible, floatable tube or are integrated into the wall of the flexible, floatable tube between two layers of the stacks.

19. The device as recited in claim 12, wherein the interior cavity of the flexible, floatable tube is filled with one of gases, gas mixtures or liquids.

20. A method for generating electrical energy from wave motions, comprising:
exposing at least one flexible, floatable tube to wave motions of water, wherein the least one flexible, floatable tube is closed at two ends and includes a wall which has at least one horizontal stack extending in the longitudinal direction of the flexible, floatable tube, and wherein the at least one stack has at least one layer which includes one tier made of an electroactive polymer and at least one tier serving as a flexible electrode, wherein the exposure to the wave motions of water causes sections of the at least one horizontal stack to be one of strained or compressed such that the electroactive polymer tier in the compressed sections is charged with the aid of control electronics; and
extracting, by a capacitive discharge mechanism, excess electrical energy resulting from subsequent relaxation of the sections which were one of strained or compressed and the associated separation of charges in the electroactive polymer tier in the sections which were one of strained or compressed.
